(19) United States
(12) Patent Application Publication
(10) Pub. No.: US 2010/0123271 A1
(43) Pub. Date: May 20, 2010

(54) REINFORCED ELASTOMER PRODUCTS

(76) Inventor: James Benjamin Hobbins, Waunakee, WI (US)

Correspondence Address: FOLEY & LARDNER LLP, 150 EAST GILMAN STREET, P.O. BOX 1497, MADISON, WI, 53701-1497, US

(21) Appl. No.: 12/618,431

(22) Filed: Nov. 13, 2009

Related U.S. Application Data
(63) Continuation-in-part of application No. 12/610,617, filed on Nov. 2, 2009.
Application No. 12/610,617 is a continuation of application No. 11/680,408, filed on Feb. 28, 2007, now abandoned.
(60) Provisional application No. 61/114,907, filed on Nov. 14, 2008.
(60) Provisional application No. 60/778,030, filed on Mar. 1, 2006.

(51) Int. Cl. B29C 45/14

(52) U.S. Cl. 264/320; 425/110; 264/328.1

(57) ABSTRACT

A molding system includes a top mold, a first post mounted to the top mold, a bottom mold, a second post mounted to the bottom mold, and a holding pin mounted to one of the first post or the second post. The first post is configured to contact an outer surface of a reinforcement shell when the molding system is in a closed configuration. The second post is configured to contact the outer surface of the reinforcement shell when the molding system is in the closed configuration. The holding pin is configured to secure the reinforcement shell in place when the molding system is in the closed configuration.

### CROSS-REFERENCES TO RELATED APPLICATIONS

This application is a continuation-in-part application of U.S. patent application Ser. No. 12/610,617, filed on Nov. 2, 2009, which is a continuation of U.S. patent application Ser. No. 11/680,408 filed on Feb. 28, 2007, which claims priority to U.S. Provisional Patent Application No. 60/778,030 filed on Mar. 1, 2006, the entire disclosures of which are incorporated herein by reference. This application also claims priority to U.S. Provisional Patent Application No. 61/114,907 filed Nov. 14, 2008, the entire disclosure of which is incorporated herein by reference.

### FIELD

The subject of the disclosure relates generally to products made of elastomer. More specifically, the disclosure relates to elastomer products and components that include fiber braid reinforcement shells such that resulting elastomer products are stronger, longer lasting, and more environmentally friendly.

### BACKGROUND

Industries of all kinds and consumers have been using soft elastomer products and components for decades. Soft elastomer products come in an extensive variety of shapes and sizes designed for a variety of different uses. Advantages of soft elastomer products over other hard surface products include their flexibility, their soft feel, their ability to provide soft protection for people and objects, their ability to absorb physical and acoustic shock, their grip ability, their ability to allow superior blood flow in hands when gripped tightly, their lifelike look and feel, and their overall effectiveness. The inventor has perceived that one problem with use of soft elastomers in industry and by consumers has been their robustness. Specifically, the inventor has perceived that soft elastomer products tend to wear out more quickly than hard surface product substitutes.

### SUMMARY

An illustrative molding system includes a top mold, a first post mounted to the top mold, a bottom mold, a second post mounted to the bottom mold, and a holding pin mounted to one of the first post or the second post. The first post is configured to contact an outer surface of a reinforcement shell when the molding system is in a closed configuration. The second post is configured to contact the outer surface of the reinforcement shell when the molding system is in the closed configuration. The holding pin is configured to secure the reinforcement shell in place when the molding system is in the closed configuration.

An illustrative method includes placing a reinforcement shell into a molding system that includes a top mold, a first post mounted to the top mold, a bottom mold, and a second post mounted to the bottom mold. The reinforcement shell is placed such that at least one holding pin extends into an interior of the reinforcement shell, where the at least one holding pin is mounted to one of the first post or the second post. The molding system is placed into a closed configuration such that the first post and the second post are in contact with an outer surface of the reinforcement shell. An elastomer is injected into the molding system to form a reinforced elastomer product that includes the reinforcement shell.

Another illustrative method includes placing a reinforcement shell into a molding system that includes a top mold, a first post mounted to the top mold, a bottom mold, and a second post mounted to the bottom mold. An insert is placed into an interior of the reinforcement shell, where the insert includes a first fin configured to contact the reinforcement shell at a first location adjacent to the first post when the molding system is in a closed configuration and a second fin configured to contact the reinforcement shell at a second location adjacent to the second post when the molding system is in the closed configuration. The molding system is placed into the closed configuration. An elastomer is injected into the molding system to form a reinforced elastomer product that includes the reinforcement shell.

### BRIEF DESCRIPTION OF THE DRAWINGS

Exemplary embodiments will hereafter be described with reference to the accompanying drawings.

FIGS. 1A and 1B illustrate perspective views of a fiber braid reinforcement shell for a soft bait lure in accordance with an exemplary embodiment.

FIG. 2 is an inside view of a circular fiber braid reinforcement shell for a soft bait lure in accordance with an exemplary embodiment.

FIG. 3 is a partial inside view of an ovular fiber braid reinforcement shell for a soft bait lure in accordance with an exemplary embodiment.

FIG. 4 is a side view of the fiber braid reinforcement shell in accordance with an exemplary embodiment.

FIG. 5 is an internal side view of a multi-diameter fiber braid reinforcement shell in accordance with an exemplary embodiment.

FIG. 6 is an internal side view of a uniform fiber braid reinforcement shell in accordance with an exemplary embodiment.

FIG. 7 is an internal side view of a plurality of fiber braid reinforcement shells for use in distinct locations of a soft bait lure in accordance with an exemplary embodiment.

FIG. 8 is an internal side view of a layered fiber braid reinforcement shell in accordance with an exemplary embodiment.

FIG. 9 is a cut-away perspective view of a fiber braid reinforcement shell with an open micro-chamber in accordance with an exemplary embodiment.

FIG. 10 is a cut-away perspective view of a fiber braid reinforcement shell with a closed micro-chamber in accordance with an exemplary embodiment.

FIG. 11A is a cut-away perspective view of a layered fiber braid reinforcement shell with a closed micro-chamber in accordance with an exemplary embodiment.

FIG. 11B is a cut-away perspective view of a layered fiber braid reinforcement shell with an open micro-chamber in accordance with an exemplary embodiment.

FIG. 12 illustrates cross sectional views of a plurality of soft bait lures which include various fiber braid reinforcement shell configurations in accordance with an exemplary embodiment.

FIG. 13 illustrates cross sectional views of a plurality of soft bait lures which include various fiber braid reinforcement shell configurations with closed micro-chambers in accordance with an exemplary embodiment.

FIG. 14 illustrates cross sectional views of a plurality of soft bait lures which include various fiber braid reinforcement shell configurations with sectioning in accordance with an exemplary embodiment.

FIG. 15 is a cut-away perspective view of a fiber braid reinforcement shell with an open micro-chamber in accordance with an exemplary embodiment.

FIG. 16 is a cut-away perspective view of a hook locked in place by a fiber braid reinforcement shell in accordance with an exemplary embodiment.

FIG. 17 is a cut-away perspective view of a hook locked in place by a layered fiber braid reinforcement shell in accordance with an exemplary embodiment.

FIGS. 18-20 are perspective views of barbed hooks locked in place by one or more fiber braid reinforcement shells in accordance with an exemplary embodiment.

FIG. 21 is a side view of a calibrated line threading mechanism in accordance with an exemplary embodiment.

FIG. 22 is a side view of a calibrated micro-insert plunger in accordance with an exemplary embodiment.

FIG. 23 illustrates a plurality of micro-inserts in accordance with an exemplary embodiment.

FIG. 24 is a cross sectional view of a worm-shaped soft bait lure which includes micro-inserts in accordance with an exemplary embodiment.

FIG. 25 is a perspective view of a crawfish soft bait lure in accordance with an exemplary embodiment.

FIG. 26 is a side view of a shad soft bait lure in accordance with an exemplary embodiment.

FIG. 27 is a cut-away perspective view of a tube-shaped soft bait lure in accordance with an exemplary embodiment.

FIG. 28 is a side view of micro-fiber flocking reinforcement incorporated into an elastomer in accordance with an exemplary embodiment.

FIGS. 29A-29E are partial cross-sectional side views of molding systems for creating a reinforced elastomer product in accordance with illustrative embodiments.

FIGS. 30A and 30B are partial cross-sectional side views of molding systems for creating a reinforced elastomer product with an open micro-chamber in accordance with illustrative embodiments.

FIG. 31 is a partial cross-sectional side view of a molding system for compressing a reinforcement shell in accordance with an illustrative embodiment.

### DETAILED DESCRIPTION

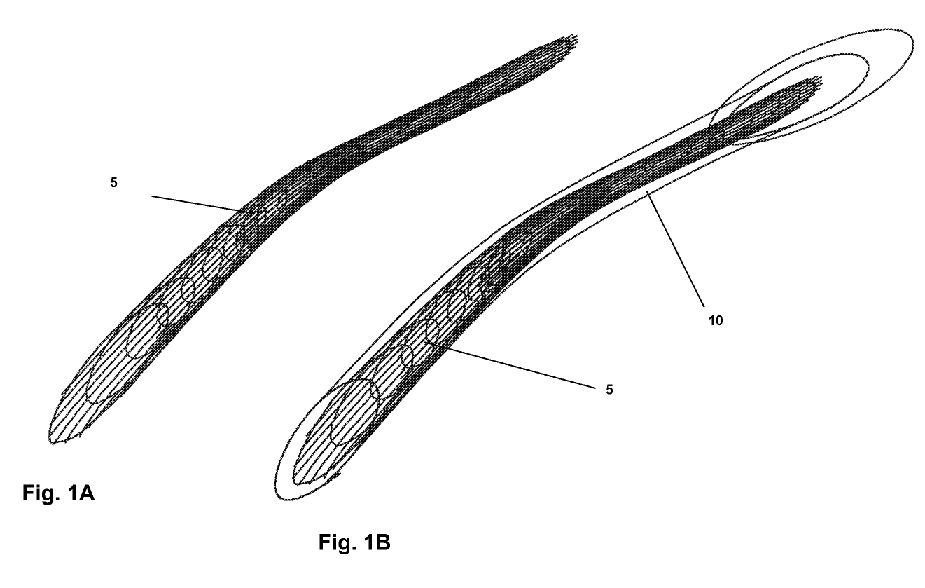

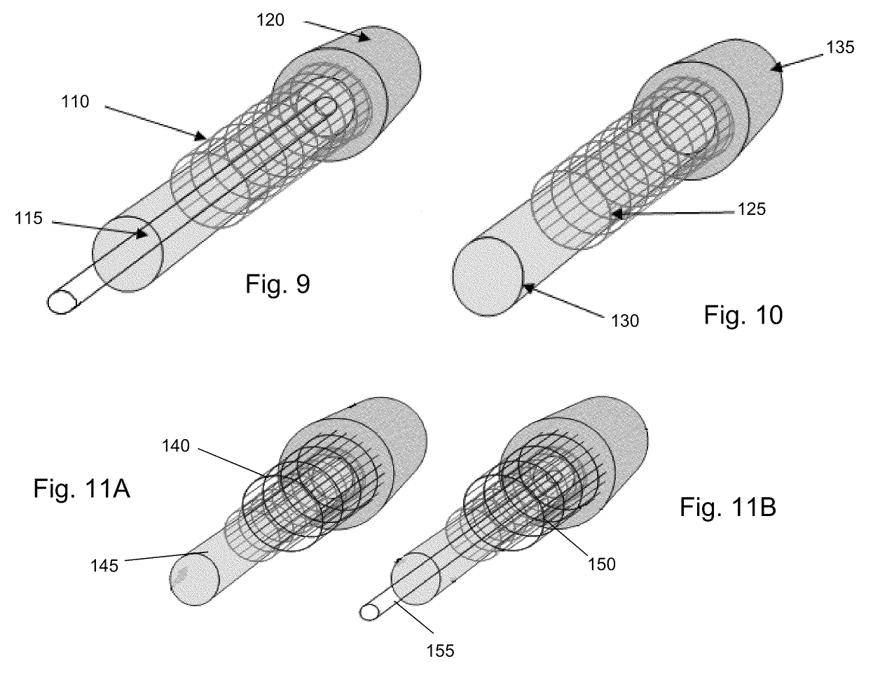

FIG. 1 illustrates perspective views of a fiber braid reinforcement shell 5 for a soft bait lure in accordance with an exemplary embodiment. FIG. 1A is a perspective view of the fiber braid reinforcement shell (FBRS) 5 prior to being incorporated into the soft bait lure. FIG. 1B is a perspective view of the FBRS 5 incorporated within a body 10 of the soft bait lure. In an exemplary embodiment, the FBRS 5 can be completely enclosed within the body 10. Alternatively, one or more portions of the FBRS 5 may extend outward from the body 10. In one embodiment, an end of the FBRS 5 can be flush with an outer edge of the body 10 such that hooks and other inserts can easily be placed within a micro-chamber of the FBRS 5. The micro-chamber is described in more detail with reference to FIGS. 9-11.

The FBRS 5 can be used to provide a soft bait lure that is both strong and flexible. The fiber used to create the FBRS 5 can be made from any combination of natural, synthetic, and/or metallic material. For example, the fiber in the FBRS 5 can be linen fiber, cotton fiber, rayon fiber, polyester fiber, dacron fiber, polyethylene fiber, polyvinyl fiber, acrylic fiber, olefin fiber, nylon fiber, nylon hybrid fiber, mylar fiber, Kevlar fiber, carbon and/or graphite fiber, stainless steel fiber, any other polymer plastic fiber, any other metallic fiber, etc. The specific material used can depend on the desired tensile strength of the shell, the desired flexibility of the shell, and the desired properties of the soft bait lure. The FBRS 5 is not meant to be limited to fibers that are braided together. The FBRS 5 can be created using any fiber braiding, weaving, meshing, netting, honeycombing, etc. method known to those of skill in the art. In an exemplary embodiment, the FBRS 5 can be composed of a plurality of single fiber strands. Alternatively, the FBRS 5 can be composed of a plurality of multi-fiber strands. The multi-fiber strands can be composed from one or more single fiber strands that are braided, weaved, or twisted or otherwise bound together. The individual fiber strands used to create the multi-fiber strands can be of the same type, or different such that each multi-fiber strand can include a plurality of fiber types. In one embodiment, a single fiber strand can be used to create the FBRS 5. The fiber strand(s) used to create the FBRS 5 can be of any diameter depending on the desired tensile strength, desired flexibility, desired weight, and other factors. The FBRS 5 can be created at any length and any diameter (or width) such that a vast array of soft bait lures can be created. For example, an FBRS for insertion in a soft bait lure used to catch perch can be several inches in length, an FBRS for insertion in a soft bait lure used to catch musky can be a foot or more in length, and an FBRS for insertion in a soft bait lure used to catch tuna or marlin can be several feet or more in length.

In an exemplary embodiment, the fiber braid reinforcement shell (FBRS) 5 can be multi-directionally flexible such that the soft bait lure is flexible in a plurality of planes. For example, the FBRS 5 can allow flexibility within a plane that is parallel to a water surface. By twitching his/her fishing pole from side to side, a fisherman can cause the FBRS 5 and the body 10 of the soft bait lure to slither through the water similar to a snake or centipede. The FBRS 5 can also allow flexibility within a plane that is perpendicular to the water surface such that the fisherman can cause the FBRS 5 and the body 10 of the soft bait lure to go up and down in the shape of a sinusoid. The FBRS 5 can also provide flexibility in planes at any other angles relative to the surface of the water. In addition, the FBRS can allow the soft bait lure to move simultaneously in a plurality of such planes. For example, a front portion of the soft bait lure can be made to wiggle from left to right while a rear portion of the soft bait lure is made to wiggle up and down.

In an exemplary embodiment, the body 10 of the soft bait lure can be made from any resilient material that is capable of being molded to the fiber braid reinforcement shell 5. For example, the body 10 of the soft bait lure can be made from any type of elastomer. In an exemplary embodiment, the elastomer or other material used to create the body 10 can include a flavor and/or scent attractant capable of attracting fish. Alternatively, an attractant may not be incorporated into the body 10. In alternative embodiments, the body 10 of the soft bait lure can be made from any combination of elastomer, plastic, plastisol, polyvinyl, rubber, gelatin, flavoring additive, and any other resilient material used in soft bait lure manufacturing as known to those skilled in the art. Alternatively, the body 10 can be made from any other material known to those of skill in the art. In an exemplary embodiment, the FBRS 5 can be placed in the body 10 of the soft bait lure during a molding process used to create the body. In one embodiment, a co-extrusion molding process can be used during which the FBRS 5 and the body 10 of the soft bait lure are extruded and molded simultaneously. Alternatively, any other molding process known to those of skill in the art can be used. For example, the soft bait lure can be created by injection, extrusion, pouring, dipping, rotary molding, etc.

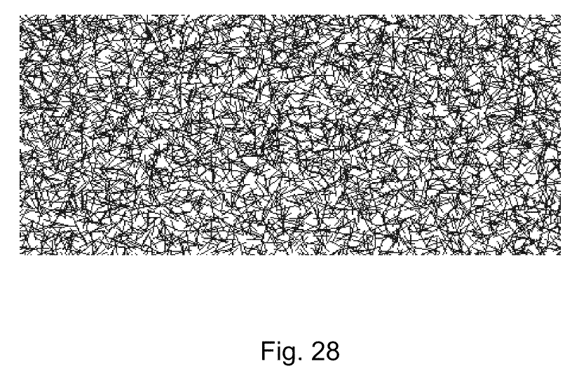

In one embodiment, natural and/or artificial micro-fiber flocking reinforcements can be compounded into the body 10 of the soft bait lure to provide additional reinforcement to body 10 of the soft bait lure. The micro-fiber flocking reinforcements can be composed from any natural and/or synthetic micro-fiber that is capable of being compounded with an elastomer or other material used to form the body 10 of the soft bait lure. FIG. 28 illustrates micro-fiber flocking reinforcement incorporated into an elastomer in accordance with an exemplary embodiment. In an exemplary embodiment, the micro-fiber flocking reinforcements can crosshatch and cure together within the elastomer compound during the molding process. In one embodiment, the micro-fiber flocking reinforcements can include a flavor or scent that is capable of attracting a fish.

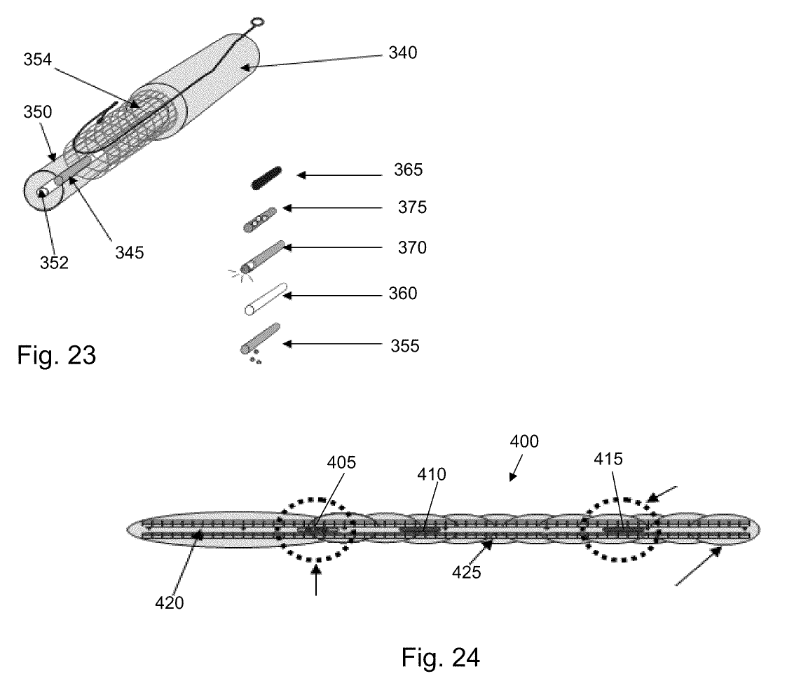

In an exemplary embodiment, the FBRS 5 can be used to vary properties of the soft bait lures in which the FBRS 5 is to be placed. For example, a diameter, weight, length, strength, expandability, color, shimmer, and shape of the soft bait lure can all be altered by adjusting the FBRS 5. These properties can be controlled by the fiber material used to create the FBRS 5 and/or coating or other materials applied to the FBRS 5. For example, a lightweight FBRS can be used in soft bait lures which are to float on the surface of the water and a heavier FBRS can be used in deep diving soft bait lures. The weight of the FBRS can depend on the fiber with which the FBRS is constructed. Similarly, in soft bait lures with translucent or transparent bodies, the FBRS can be made to shimmer such that fish are more attracted to the soft bait lure. The shimmer can be provided by the fiber material used to create the FBRS and/or a paint or other coating applied to the FBRS. The tensile strength of the FBRS can also be altered by the strength of the fiber used to create the FBRS. A desired tensile strength can depend on the fish species for which the soft bait lure is to be used (i.e., higher tensile strength for larger fish). In translucent or transparent soft bait lures, the FBRS can be also used to control the interior color of the soft bait lure. For example, the fibers of the FBRS can be selected, painted, or coated such that the fibers are the color capable of attracting fish. In an exemplary embodiment, the FBRS can also be expandable such that oversized inserts can be securely locked in place within the FBRS. Inserts are described in more detail with reference to FIG. 23.

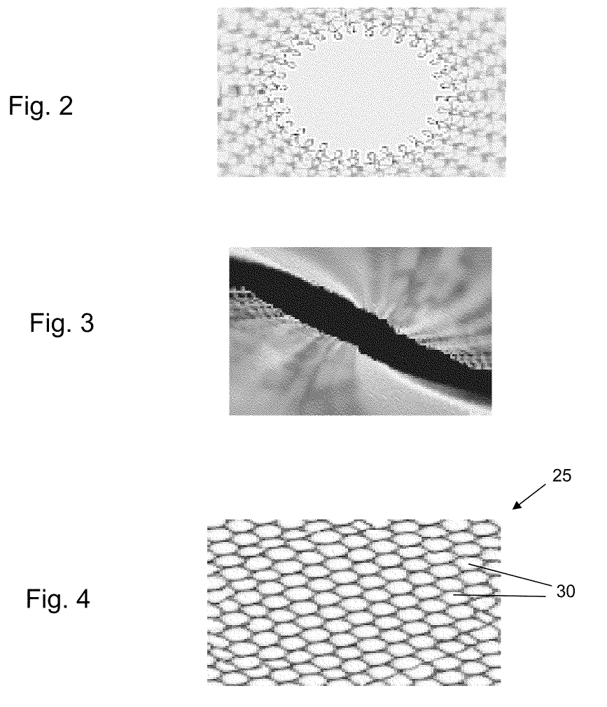

FIG. 2 is an inside view of a circular fiber braid reinforcement shell (FBRS) for a soft bait lure in accordance with an exemplary embodiment. The FBRS diameter illustrated with reference to FIG. 2 is not meant to be limiting. Fiber braid reinforcement shells can be made with any diameter(s), depending on a desired size of the soft bait lure. FIG. 3 is a partial inside view of an ovular fiber braid reinforcement shell for a soft bait lure in accordance with an exemplary embodiment. In alternative embodiments, the FBRS can be any other shape including square, triangular, rectangular, octagonal, etc.

FIG. 4 is a side view of a fiber braid reinforcement shell 25 in accordance with an exemplary embodiment. The FBRS 25 includes a plurality of apertures 30 capable of receiving hooks and keeping them substantially locked in place. The size of the apertures 30 illustrated with reference to FIG. 2 is not meant to be limiting. In alternative embodiments, there can be more or less space between the fibers such that the apertures 30 can be larger or smaller. For example, a loosely spaced FBRS can be used to create a soft bait lure with enhanced flexibility. Similarly, a more tightly spaced FBRS can be used to further enhance the strength of the soft bait lure.

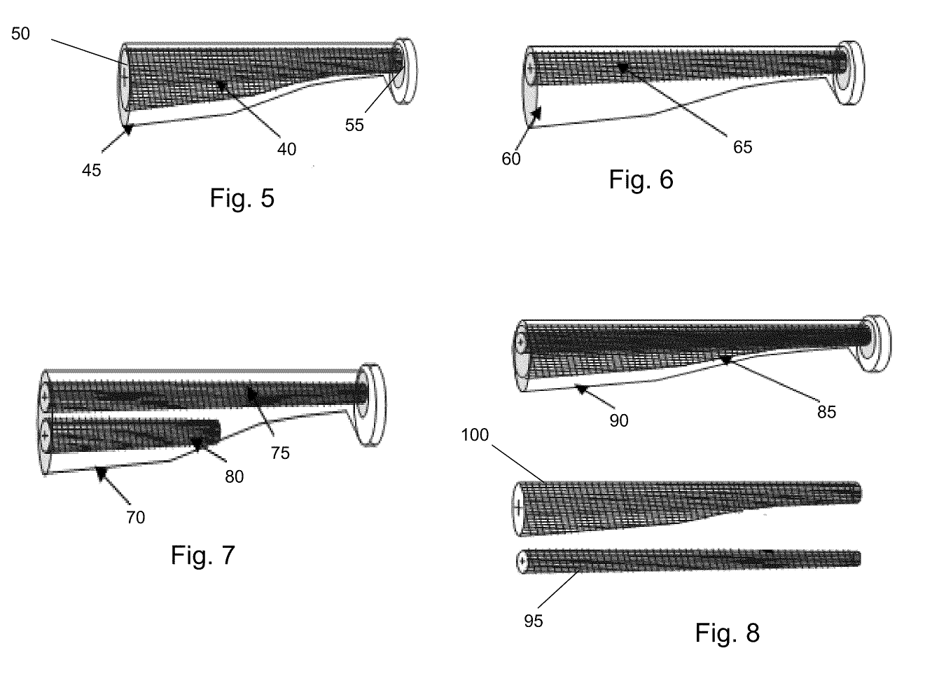

In an exemplary embodiment, fiber braid reinforcement shells of various shapes, sizes, and configurations can be used in various soft bait lures. As an example, FIG. 5 is an internal side view of a multi-diameter fiber braid reinforcement shell 40 within a body 45 in accordance with an exemplary embodiment. The multi-diameter FBRS 40 is a first (larger) diameter at a first end 50, and a second (smaller) diameter at a second end 55. The multi-diameter FBRS 40 tapers in a non-uniform manner along its bottom. Alternatively, the multi-diameter FBRS 40 can taper in a uniform manner such that it forms a partial cone. In another alternative embodiment, there may not be a taper, but rather an abrupt, ninety-degree boundary between the first diameter and the second diameter. FIG. 6 is an internal side view of a fiber braid reinforcement shell 65 that is uniform in diameter and within a body 60 of a soft bait lure in accordance with an exemplary embodiment.

FIG. 7 is an internal side view of a plurality of fiber braid reinforcement shells for use in distinct locations of a body 70 of a soft bait lure in accordance with an exemplary embodiment. A first FBRS 75 is of a greater length than a second FBRS 80. In alternative embodiments, any or all of a plurality of fiber braid reinforcement shells can be the same length. In one embodiment, any of the properties of FBRSs within the plurality of FBRSs can differ. For example, a first FBRS can be adapted to shimmer and a second FBRS can be painted green, or the tensile strength of a first FBRS can differ from the tensile strength of a second FBRS. In an exemplary embodiment, a soft bait lure can include any number of individual FBRSs, including three, four, five, etc. The FBRSs can be placed side by side within the soft bait lure, on top of one another, or at any other orientation with respect to one another.

FIG. 8 is an internal side view of a layered fiber braid reinforcement shell 85 in accordance with an exemplary embodiment. A first FBRS 95 is adapted to fit inside of a second FBRS 100 to form the layered FBRS 85 within a body 90 of a soft bait lure. In alternative embodiments, the layered FBRS 85 can include three, four, five, or any other number of individual FBRSs layered within one another. The layered FBRSs can be the same shape or different, depending on the embodiment. In an exemplary embodiment, the layered FBRS 85 can be used to provide a stronger soft bait lure and/or to enhance the ability of the FBRS to lock a hook in place.

In an exemplary embodiment, an interior of an FBRS can be referred to as a micro-chamber. In another exemplary embodiment, an FBRS can either have an open micro-chamber or a closed micro-chamber. An open micro-chamber can refer to a micro-chamber which is not filled with the resilient material used to create the body of the soft bait lure or any other material such that one or more chambers exist in the interior of the soft bait lure. A closed micro-chamber can refer to a micro-chamber which is filled with the resilient material used to create the body of the soft bait lure such that there is no open space in the interior of the soft bait lure. Alternatively, the closed micro-chamber can be filled with any other material. For example, the closed micro-chamber can be filled in part with natural and/or artificial micro-fiber flocking reinforcements to provide additional reinforcement to the soft lure. In an exemplary embodiment, a closed micro-chamber can be used in soft bait lures in which hooks, line, and/or any other micro-inserts are molded into the soft bait lure by the soft bait lure manufacturer. Open micro-chambers can be used in soft bait lures in which the user manually inserts, hooks, line, and/or any other micro-inserts into the soft bait lure. The open micro-chamber can make it easier to access and manipulate any inserts desired by the user. Alternatively, users can place inserts in soft bait lures with closed micro-chambers and/or manufacturers can place inserts into soft bait lures with open micro-chambers. In an exemplary embodiment, the molding process used to create the soft bait lure can be used to control whether the micro-chamber is open or closed.

FIG. 9 is a cut-away perspective view of a fiber braid reinforcement shell (FBRS) 110 with an open micro-chamber 115 in accordance with an exemplary embodiment. The FBRS 110 is in a body 120 of a soft bait lure. In an exemplary embodiment, the open micro-chamber 115 can run the length of the FBRS 110. Alternatively, the open micro-chamber 115 can be shorter than or longer than the FBRS 110. In one embodiment, a diameter of the open micro-chamber 115 can be approximately the same diameter as the FBRS 110 in which the open micro-chamber 115 is located. Alternatively, the diameter of the open micro-chamber 115 can be smaller or larger than the diameter of the FBRS 110. In one embodiment, the open micro-chamber 115 can be divided into a plurality of sub-chambers such that there are a plurality of open micro-chambers within a single FBRS. In embodiments that include a plurality of FBRSs, each individual FBRS can include one or more open micro-chambers. In one embodiment, the open micro-chamber 115 can include a hollow tube-shaped insert. The hollow tube-shaped insert can be a flexible plastic tube, a cloth tube, an FBRS such that a layered FBRS is formed, or any other insert which does not inhibit the multi-directional flexibility of the soft bait lure. The hollow tub-shaped insert can be smooth or notched depending on the embodiment. Open micro-chambers which do not include the hollow tube can also be smooth or notched, depending on the embodiment. Notches can be molded into the elastomer (or other material) during molding of the soft bait lure. FIG. 10 is a cut-away perspective view of a fiber braid reinforcement shell 125 with a closed micro-chamber 130 in accordance with an exemplary embodiment. The closed micro-chamber can be filled with the same material used to create a body 135 of the soft bait lure, or a different material, depending on the embodiment.

FIG. 11A is a cut-away perspective view of a layered fiber braid reinforcement shell 140 with a closed micro-chamber 145 in accordance with an exemplary embodiment. FIG. 11B is a cut-away perspective view of a layered fiber braid reinforcement shell 150 with an open micro-chamber 155 in accordance with an exemplary embodiment. In an exemplary embodiment, the open micro-chamber(s) in a layered FBRS can be within the innermost individual FBRS. Alternatively, one or more open micro-chambers can be placed in between adjacent fiber braid reinforcement shells that make up the layered FBRS.

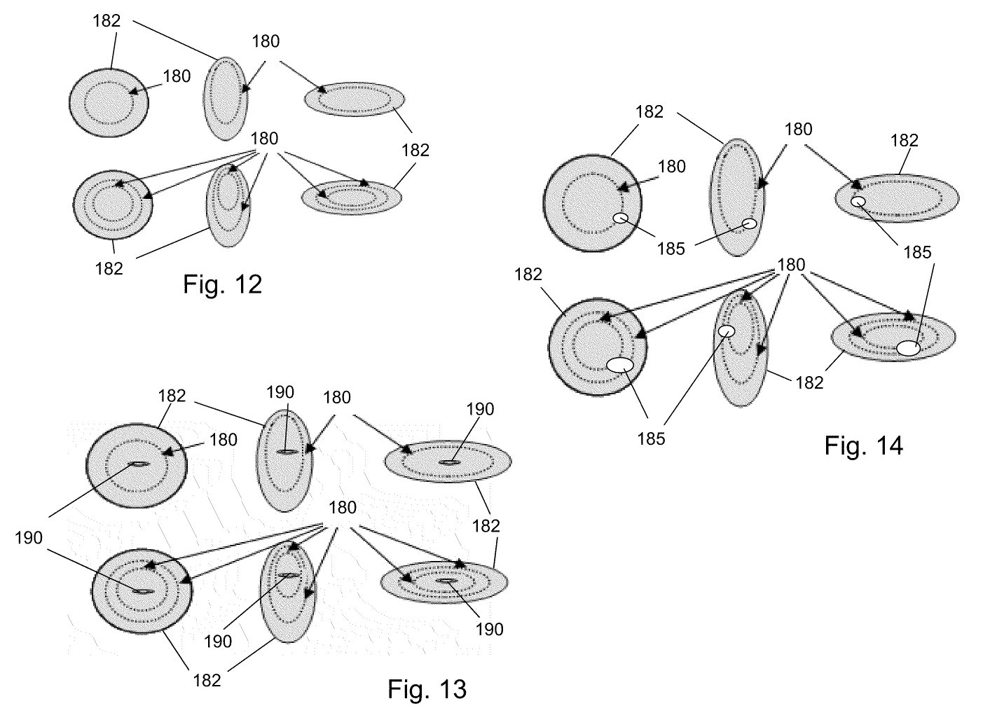

FIG. 12 illustrates cross sectional views of a plurality of soft bait lures which include various configurations of a fiber braid reinforcement shell (FBRS) 180 in accordance with an exemplary embodiment. In an exemplary embodiment, there can be a plurality fiber braid reinforcement shell 180 within a single body 182 of a soft bait lure. The plurality of FBRS 180 can be inside of one another (layered), side by side, on top of one another, etc. FIG. 13 illustrates cross sectional views of a plurality of soft bait lures which include various configurations of the fiber braid reinforcement shell 180 with sections 185 in accordance with an exemplary embodiment. The sections 185 can be used to add modular flexibility to the FBRS 180 such that the FBRS 180 can be used to create magnum or other soft bait lures. The sections 185 can refer to channels or cavities molded into the soft bait lure and capable of receiving hook and/or lure sets such that a hybrid soft bait lure can be formed. In an exemplary embodiment, the FBRS 180 can wrap around hooks and lure sets within the sections 185 in a tubular fashion, while preserving the expandable, multi-directionally flexible properties of the soft bait lure. The sections 185 can run a partial length or the entire length of the soft bait lure body, depending on the embodiment. In one embodiment, the hook and/or lure sets can be molded into the body 182 during the molding process used to form the body 182. Alternatively, the hook and/or lure sets can be inserted after the body 182 is formed. FIG. 14 illustrates cross sectional views of a plurality of soft bait lures which include various configurations of the fiber braid reinforcement shell 180 with open micro-chambers 190 in accordance with an exemplary embodiment. In alternative embodiments, the FBRSs can be any other shapes and/or placed in any other configuration within the soft bait lure. Similarly, the open micro-chambers 190 can be any other shape and/or placed in any other configuration within the soft bait lure.

In an exemplary embodiment, an FBRS can also be used within soft bait components that are used to form a hybrid or combination fishing lure. The soft bait component can be a leg which extends from the hybrid fishing lure, a tail which extends from the hybrid fishing lure, a portion of a body of the hybrid fishing lure, or any other portion of the hybrid fishing lure. For example, a hybrid musky fishing lure can include a hard plastic body and a soft bait tail with an FBRS. In an exemplary embodiment, the soft bait tail can be a mix and match tail that can easily be attached to and/or removed from the hybrid fishing lure. Alternatively, the soft bait tail can be permanently mounted to the hybrid fishing lure.

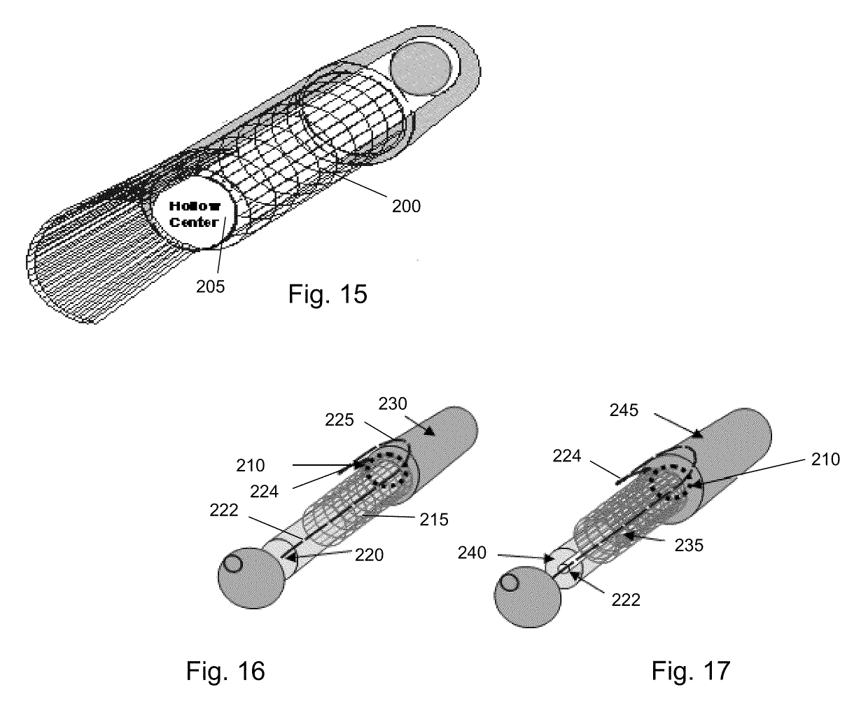

FIG. 15 is a cut-away perspective view of a fiber braid reinforcement shell 200 with an open micro-chamber 205 in accordance with an exemplary embodiment. The open micro-chamber 205 includes a hollow center which is capable of receiving a hook body, fishing line, and/or other micro-inserts. In one embodiment, the hollow center of the open micro-chamber can include a hollow tube-shaped or other insert capable of receiving inserts. The open micro-chamber and/or the hollow tube can be smooth or notched depending on the embodiment. Notches in a notched open micro-chamber can act as locking mechanisms for holding inserts in place.

FIG. 16 is a cut-away perspective view of a hook 210 locked in place by a FBRS 215 with a closed micro-chamber 220 in accordance with an exemplary embodiment. The hook 210 includes a shaft 222, a point 224, and a curved portion 225. The point 224 of the hook 210 extends through a body 230 of the soft bait lure, and is substantially locked in place through contact between the curved portion 225 of the hook 210 and the FBRS 215. In an exemplary embodiment, the body 230 of the soft bait lure helps keep the hook 210 substantially locked in place. FIG. 17 is a cut-away perspective view of the hook 210 substantially locked in place within a layered FBRS 235 with an open micro-chamber 240 in accordance with an exemplary embodiment. The point 224 of the hook 210 extends through a body 245 of the soft bait lure and is substantially locked in place through contact between the curved portion 225 of the hook 210 and the layered FBRS 235. In an exemplary embodiment, the body 245 of the soft bait lure also helps keep the hook 210 substantially locked in place.

In an exemplary embodiment, hooks can be locked in place manually in the field by a user. In an exemplary embodiment, a soft bait lure can include a front end (to which fishing line can be tied) and a back end that trails in the water. A user can insert a point of the hook into a micro-chamber of the FBRS and position the hook such that the point is pointing toward the front of the soft bait lure. The user can push the hook toward the back end of the soft bait such that the curved portion of the hook passes through the micro-chamber and the point of the hook does not get caught in the FBRS. Upon inserting the hook to a desired position, the user can pull the hook forward and cause the point and at least a portion of the curved portion of the hook to go through the FBRS and come out of the body of the soft bait lure. The user can pull the hook forward until it is substantially locked in place through contact between the hook and the fibers of FBRS. In an exemplary embodiment, at least a portion of the shaft of the hook can remain in the micro-chamber. As a result, the hook can be locked within an aperture of the plurality of apertures that make up the FBRS. In an exemplary embodiment, any movement of the hook may be limited to the size of the aperture through which the hook is inserted. However, the movement of the hook is limited by the body of the soft bait lure such that overall hook movement can be minute. In an alternative embodiment, the hook can be inserted in the opposite direction, i.e., from the back end of the lure to the front end of the lure.

In one embodiment, the hook can be locked into the FBRS of the soft bait lure such that the shaft of the hook is perpendicular to the FBRS. For example, the user can cause the point of the hook to pierce the body of the soft bait lure on a first side, pierce the FBRS on a first side, go through the micro-chamber of the FBRS, pierce the FBRS on a second side, and pierce the body of the soft bait lure on a second side. In alternative embodiments, the user can insert the hook by any method such that the hook is locked in place by the FBRS. In an exemplary embodiment, the user can insert hooks into soft bait lures that include an open micro-chamber. Alternatively, users can also insert hooks into soft bait lures that include a closed micro-chamber. In an exemplary embodiment, the hook can be any type of fishing hook known to those of skill in the art, including a barbed hook, a barbless hook, a single hook, a treble hook, a weighted hook, a floating hook, a jig hook, a hook attached to a hard or soft lure, etc.

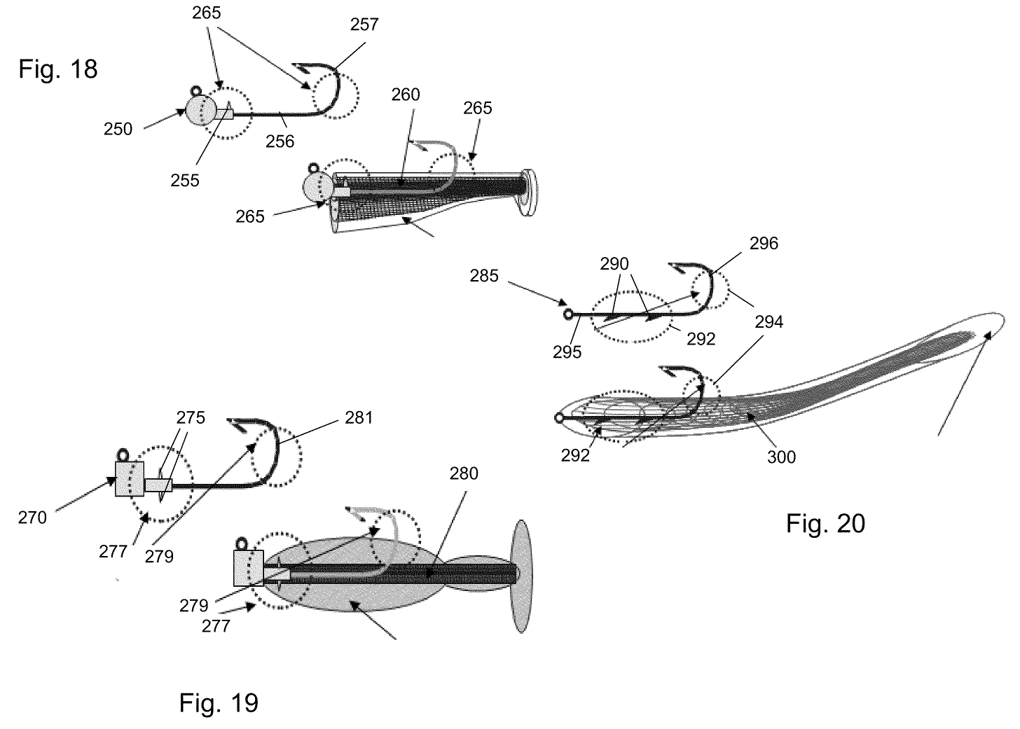

FIGS. 18-20 are internal perspective views of barbed hooks locked in place by one or more fiber braid reinforcement shells in accordance with an exemplary embodiment. In an exemplary embodiment, the barbs on the hooks can function as additional locking points such that the hook is further secured to the FBRS. FIG. 18 illustrates a barbed hook 250 that includes a barb 255, a shaft 256, and a curved portion 257. In an exemplary embodiment, the barb 255 and the curved portion 257 can be locking points 265 at which the barbed hook 250 is locked to a layered FBRS 260. FIG. 19 illustrates a barbed hook 270 that includes two barbs 275 for locking into an FBRS 280. As such, the barbed hook 270 can include two locking points 277 at the location of the barbs 275 and one locking point 279 at the location of a curved portion 281 of the barbed hook 270. FIG. 20 illustrates a barbed hook 285 that includes two barbs 290 on a shaft 295 of the barbed hook 285 for locking into an FBRS 300. The barbed hook 285 can be locked to the FBRS 300 at two locking points 292 at the location of the two barbs 290 and a single locking point 294 at the location of a curved portion 296 of the barbed hook 285. In alternative embodiments, any other style of hook can be used. Further, the hooks used can include any configuration and/or number of barbs.

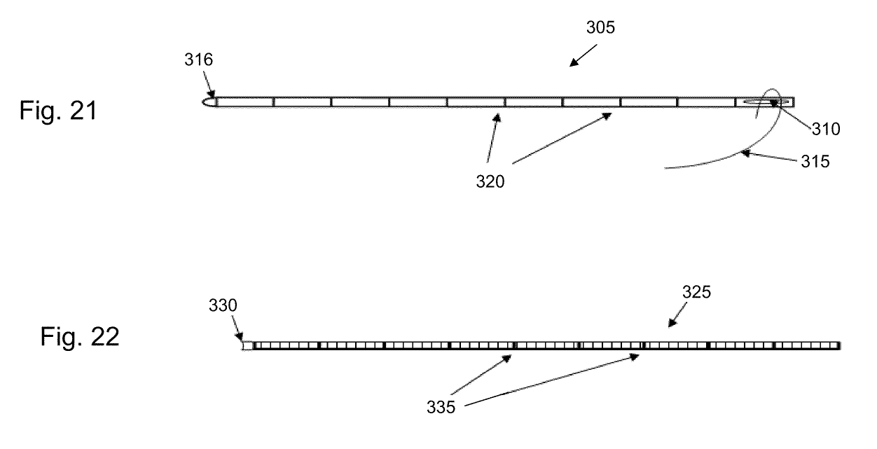

FIG. 21 is a side view of a calibrated line threading mechanism 305 in accordance with an exemplary embodiment. In alternative embodiments, the line threading mechanism 305 may not be calibrated. The line threading mechanism 305 can include a line receiving aperture 310 capable of receiving fishing line 315. In an exemplary embodiment, the line threading mechanism 305 can be used to set hooks within an FBRS and/or run fishing line through the FBRS. In an exemplary embodiment, a user can thread fishing line 315 through the line receiving aperture 310 and push the line threading mechanism 305 into and through at least a portion of a micro-chamber such that the fishing line 315 runs through at least a portion of the FBRS and the soft bait lure. The user can push the line threading mechanism 305 at a blunt end 316 such that the user does not damage his/her fingers. The line threading mechanism 305 also includes a calibration scale 320 which can be used to gauge distances in a soft body lure with a non-transparent, non-translucent body. As such, the user can easily run the fishing line 315 through a specific length of the soft body lure without having to guess. In an exemplary embodiment, the fishing line 315 can have one or more hooks tied to it such that the line threading mechanism can also be used to set and lock hooks within the soft bait lure.

FIG. 22 is a side view of a calibrated micro-insert plunger 325 in accordance with an exemplary embodiment. The micro-insert plunger 325 can be used to insert and/or remove various micro-inserts into a micro-chamber of an FBRS. The micro-insert plunger 325 includes a concave tip 330 capable of receiving a micro-insert such that the micro-insert can be positioned within a micro-chamber. In an exemplary embodiment, a micro-insert can be inserted into the concave tip 330 and a user can insert the micro-insert plunger 325 into a micro-chamber of an FBRS. The user can push the micro-insert plunger 325 until the micro-insert is at a desired location and remove the micro-insert plunger 325. In an exemplary embodiment, the micro-insert can be held in place by any of the plurality of apertures which form the FBRS. Alternatively, the micro-insert can be held in place by one or more notches within the micro-chamber of the FBRS. In one embodiment, oversized micro-inserts can be used. The oversized micro-inserts can be held in place by friction with a micro-chamber of smaller diameter. In an exemplary embodiment, the micro-chamber of smaller diameter can expand along with the expandable FBRS. The one or more notches can be in a hollow tube within the micro-chamber, or molded into the micro-chamber itself. The micro-insert plunger 325 can also include a calibration scale 335 which can be used to gauge distances in a soft body lure with a non-transparent, non-translucent body such that a micro-insert can be precisely positioned within the soft bait lure.

As an example, the concave tip 330 of the micro-insert plunger 325 can be a cavity which is capable of gripping a micro-insert. The micro-insert plunger 325 can be used to push the micro-insert into place within a micro-chamber. Because the FBRS can be expandable, the FBRS and/or micro-chamber can expand upon insertion of the micro-insert such that the micro-insert can be held firmly in place by friction. In an exemplary embodiment, the micro-insert can be removed by using the micro-insert plunger 325 to push the micro-insert out of the micro-chamber. As such, micro-inserts can be mix and match inserts which allow a fisherman to easily customize his/her soft bait lure while in the field. In a soft bait lure with a closed micro-chamber, the fisherman can use the micro-insert plunger 325 to push a micro-insert through the micro-chamber filling to insert the micro-insert within the micro-chamber. In an exemplary embodiment, micro-inserts can be inserted from either end of the FBRS.

FIG. 23 illustrates a plurality of micro-inserts in accordance with an exemplary embodiment. FIG. 23 also illustrates a soft bait lure 340 in which a micro-insert 345 has been inserted into an open micro-chamber 350 in accordance with an exemplary embodiment. In alternative embodiments, micro-chambers can be molded or otherwise placed into closed micro-chambers. In an exemplary embodiment, the micro-insert 345 can be locked in place by a hollow tube 352 within the open micro-chamber 350. The hollow tube 352 can include notches to hold the micro-insert 345 place. Alternatively, hollow tube 352 can be expandable such that the micro-insert 345 can be oversized and held in place by friction. The micro-insert 345 can also be locked into place by the expandable apertures of an FBRS 354 or notches which are molded into the micro-chamber 350. The FBRS 354 can be expandable and the micro-insert 345 can be oversized such that the micro-insert 345 is held in place by friction.

The micro-inserts which can be inserted into a soft bait lure can include a chum-flavored and/or scented insert 355 to attract fish. In an alternative embodiment, a flavor and/or a scent can be incorporated into the body of the soft bait lure, into the FBRS 354, into micro-fiber flocking used to strengthen the soft bait lure, and/or into the fill of a closed micro-chamber. Other micro-inserts can include a float insert 360 to allow the soft bait lure to float, a sinker insert 365 to cause the soft body lure to sink, a light insert 370 to attract fish in low light and/or night conditions, and a rattle insert 375 to attract fish by sound. In alternative embodiments, any other types of micro-inserts which can attract fish and/or affect the properties of the soft bait lure can be used. For example, scent inserts and/or flavor inserts of any variety can be used, any other type of sound-generating inserts can be used, any other light-generating inserts can be used, etc. In an exemplary embodiment, one or more micro-inserts can be placed into any open micro-chamber or sub-chamber within an FBRS. Alternatively, one or more micro-inserts can be molded or otherwise placed into any closed micro-chamber of the FBRS. In an exemplary embodiment, the micro-inserts can be inserted by a user using the micro-insert plunger 325 described with reference to FIG. 22. Alternatively, the micro-inserts can be molded into the soft bait lure by the lure manufacturer. In an exemplary embodiment, a micro-insert can refer to any object which is at least partially inserted into a soft bait lure. As such a micro-insert can refer to a hook, fishing line, the above-described micro-inserts, etc.

FIG. 24 is a cross sectional view of a worm-shaped soft bait lure 400 which includes micro-inserts in accordance with an exemplary embodiment. The worm-shaped soft bait lure 400 includes a rattle insert 405, a chum-flavored insert 410, and a sinker insert 415 within an open micro-chamber 420 of a fiber braid reinforcement shell 425. In alternative embodiments, the worm-shaped soft bait lure 400 can include fewer, additional, and/or different micro-inserts.

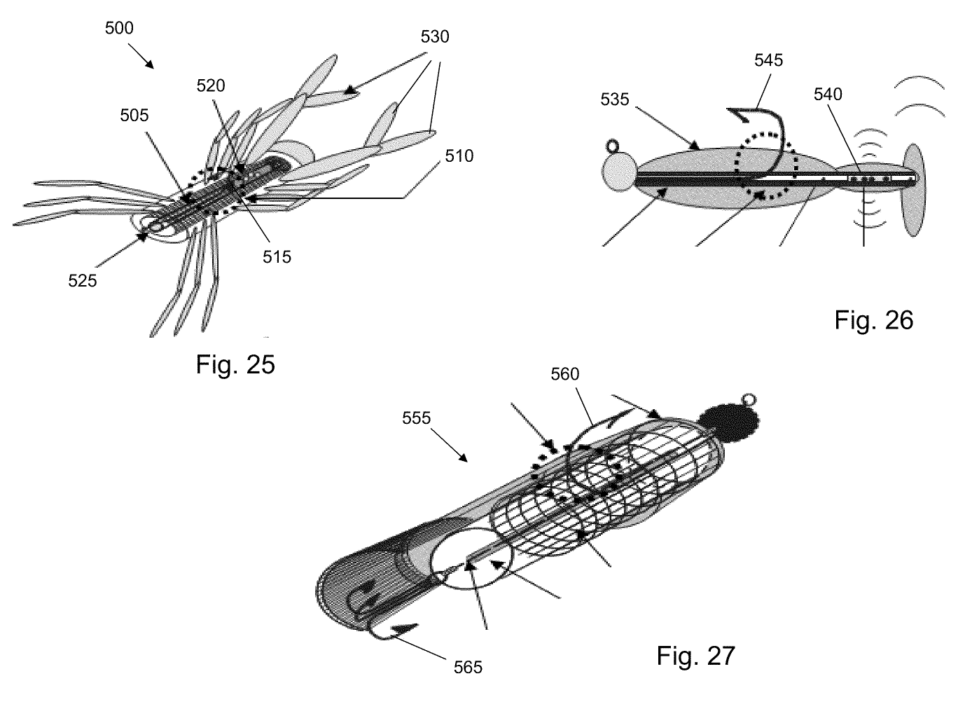

In an exemplary embodiment, soft bait lures that include an FBRS can be created to resemble any live bait or other object that is capable of attracting a fish. For example, FIG. 25 is an internal perspective view of a crawfish soft bait lure 500 in accordance with an exemplary embodiment. The crawfish soft bait lure 500 includes an FBRS 505 in a tube-shaped body 510. A hook 515 and a micro-insert 520 are locked in place within a micro-chamber 525 of the FBRS 505. The crawfish soft bait lure 500 also includes a plurality of legs 530 which extend from the tube-shaped body 510. In an alternative embodiment, one or more of the plurality of legs 530 can include an FBRS. In one embodiment, the FBRS in the legs 530 can be connected to the FBRS 505 in the tube-shaped body 510 such that the legs 530 cannot be bitten off by a fish. Alternatively, the FBRS in the legs 530 may not be connected to the FBRS 505 in the tube-shaped body 510.

FIG. 26 is a side view of a shad soft bait lure 535 in accordance with an exemplary embodiment. The shad soft bait lure 535 includes a rattle insert 540 and a hook 545. FIG. 27 is a cut-away perspective view of a solid resilient tube-shaped soft bait lure 555 in accordance with an exemplary embodiment. The tube-shaped soft bait lure 555 includes a hook 560 and a treble hook 565. In alternative embodiments, a soft bait lure with one or more FBRSs can mimic a grub, a fry, a lizard, a salamander, an eel, a snake, a frog, a squid, a plant, a bait fish of any size, or any other object or animal which is capable of attracting a fish.

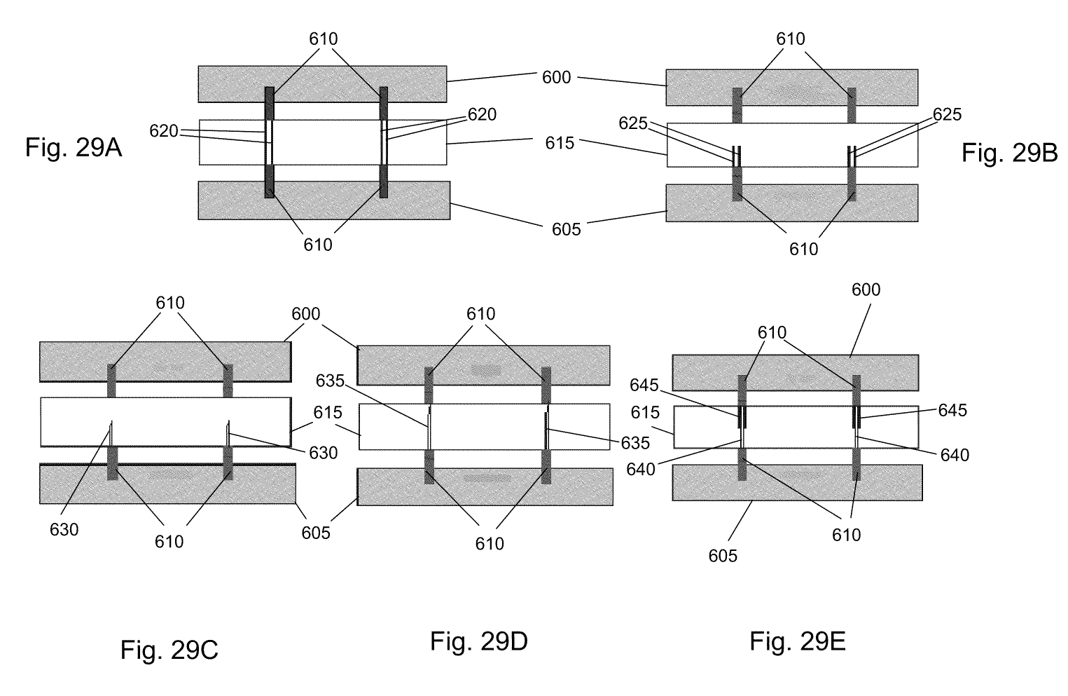

FIGS. 29A-29E are partial cross-sectional side views of molding systems for creating a reinforced elastomer product in accordance with illustrative embodiments. Each of the molding systems in FIGS. 29A-29E include a top mold tool (or top mold) 600, a bottom mold tool (or bottom mold) 605, and a plurality of posts 610. In an illustrative embodiment, top mold tool 600 and bottom mold tool 605 can be made of any material that has a higher melting point than the elastomer that is to be molded in the molding system. Illustrative materials can include steel and aluminum. Interior surfaces of top mold tool 600 and bottom mold tool 605 can each be semi-circular such that a front or rear view cross section of the molded elastomer is circular in shape. Alternatively, interior surfaces of top mold tool 600 and/or bottom mold tool 605 may take on other shapes such that the molded elastomer is ovular, square, rectangular, triangular, hexagonal, octagonal, etc. in cross section

Top mold tool 600 and bottom mold tool 605 can be placed in an open configuration and a closed configuration through the use of one or more hinges, hydraulics, pulleys, etc. For example, hydraulics, pulleys, manpower, etc. can be used to lift top mold tool 600 off of bottom mold tool 605 to place the molding system in the open configuration. Alternatively, top mold tool 600 and bottom mold tool 605 may be mounted to one another through the use of one or more hinges (not shown) such that the molding system can be opened and closed. In an illustrative embodiment, the molding system includes an opening (not shown) for receiving the elastomer. Except for the opening, the interior of molding system and the inserted reinforcement shell are sealed from the external environment by top mold tool 600, bottom mold tool 605, and one or more end walls (not shown) when the molding system is in the closed configuration. The one or more end walls may be formed at least in part by top mold tool 600 and/or bottom mold tool 605.

FIGS. 29A-29E illustrate top mold tool 600 and bottom mold tool 605 in the closed configuration. In the closed configuration, a reinforcement shell 615 is supported by posts 610 and held in place by one or more pins, which are described in more detail below. The elastomer is injected into the molding system while reinforcement shell 615 is held in place and while the molding system is in the closed configuration. In the embodiments of FIGS. 29A-29E, the elastomer fills an interior of reinforcement shell 615 such that the finished elastomer product has a closed or filled micro-chamber (or interior). The molded elastomer also surrounds the exterior of reinforcement shell 615 such that reinforcement shell 615 is encompassed within the finished elastomer product. Once the elastomer is set and/or cooled, the molding system is placed into the open configuration. In an illustrative embodiment, top mold 600 is at least partially removed from bottom mold 605 (or vice versa) to place the molding system in the open configuration. In the open configuration, the molded elastomer reinforced by reinforcement shell 615 is removed from the molding system, and a new reinforcement shell 615 can be inserted into the molding system for production of another reinforced elastomer product.

Posts 610 are used to provide support for reinforcement shell 615 during the molding process. In an illustrative embodiment, when top mold tool 600 and bottom mold tool 605 are in the closed configuration, posts 610 are in contact with an outer surface of reinforcement shell 615. Posts 610 can be made of any material (i.e., steel, brass, aluminum, etc.) that has a higher melting point than the elastomer that is to be molded in the molding system. Four posts 610 are illustrated in each of the molding systems of FIGS. 29A-29E. Additional or fewer posts may be used in alternative embodiments. Reinforcement shell 615 can be a fiber braided mesh shell that is placed into and secured by the molding system prior to injection of the elastomer. In one embodiment, a single molding system can include a plurality of molding chambers lined up side-by-side (or in any other configuration) for the mass production of reinforced elastomer. The single molding system can include a common top mold tool and a common bottom mold tool.

In one embodiment, a computer system can be used to perform at least a portion of the molding process. The computer system can include at least a processor, a memory, and a wired or wireless transceiver for communicating with the molding system and/or other machinery. The memory can be configured to store computer-readable instructions that, when executed by the processor, cause the molding system to perform any of the operations described herein for molding a reinforced elastomer. As an example, the computer system can place the molding system into the open configuration, control a robotic arm (or other machine) to place a reinforcement shell into the mold so that the reinforcement shell is secured by one or more holding pins, place the molding system in the closed configuration, and cause an injection machine to inject the elastomer into the closed molding system. The computer system can also cause a blower, water or otherwise liquid-cooled in-system tool chiller systems, independent chiller plate systems, air-conditioning unit, etc. to cool the molding system. The computer system can further place the molding system into the open configuration and use a robotic arm (or other machine) to remove the molded reinforced elastomer.

FIG. 29A illustrates an injection mold with full length holding pins 620 in accordance with an illustrative embodiment. In the illustrated embodiment, two full-length holding pins 620 extend between each pair of posts 610 of the injection mold. Holding pins 620 can be mounted to the top pair of posts 610 that are mounted to top mold tool 600 and/or to the bottom pair of posts 610 that are mounted to bottom mold tool 605. In an illustrative embodiment, holding pins 620 extend into entrance holes in reinforcement shell 615, through the interior of reinforcement shell 615 and out of exit holes in reinforcement shell 615. The entrance and exit holes can be part of the mesh configuration of reinforcement shell 615. Holding pins 620 keep reinforcement shell 615 secured in place during the injection molding process.

FIG. 29B illustrates an injection mold with holding pins 625 in accordance with an illustrative embodiment. Holding pins 625, two of which are mounted to each of bottom posts 610, extend into entrance holes of reinforcement shell 615 and into an interior of reinforcement shell 615 to secure reinforcement shell 615 during the injection molding process. Holding pins 625 extend approximately half way between bottom posts 610 and top posts 610, and do not extend all the way through the interior of reinforcement shell 615.

FIG. 29C illustrates an injection mold with holding pins 630 in accordance with an illustrative embodiment. A single holding pin 630 is mounted to each of bottom posts 610. Holding pins 630 have tapered (or pointed) ends for placement through the mesh structure of reinforcement shell 615. Holding pins 630 extend into entrance holes of reinforcement shell 615 and into an interior of reinforcement shell 615 to secure reinforcement shell 615 during the injection molding process. Holding pins 630 extend approximately half way between bottom posts 610 and top posts 610, and do not extend all the way through the interior of reinforcement shell 615.

FIG. 29D illustrates an injection mold with holding pins 635 in accordance with an illustrative embodiment. A single holding pin 635 is mounted to each of bottom posts 610. Holding pins 635 have tapered (or pointed) ends for placement through the mesh structure of reinforcement shell 615. Holding pins 635 extend into entrance holes of reinforcement shell 615, through an interior of reinforcement shell 615, and out from exit holes to secure reinforcement shell 615 during the injection molding process. Holding pins 630 extend all the way between bottom posts 610 and top posts 610.

FIG. 29E illustrates an injection mold with holding pins 640 in accordance with an illustrative embodiment. A single holding pin 640 is mounted to each of bottom posts 610. Holding pins 640 extend into entrance holes of reinforcement shell 615, through an interior of reinforcement shell 615, and into sheaths 645 that are mounted to top posts 610. Sheaths 645 extend into the interior of reinforcement shell and provide a receptacle for securing holding pins 640. As such, reinforcement shell 615 is secured during the injection molding process. In one embodiment, sheaths 645 include a plurality of members (or pins) that are configured to extend through the mesh of reinforcement shell 615 and into the interior of reinforcement shell 615.

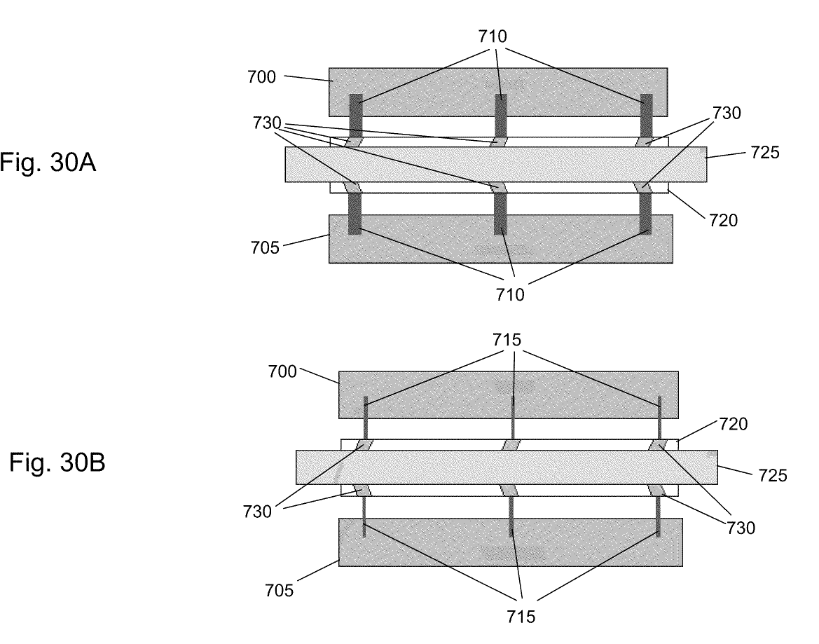

FIGS. 30A and 30B are partial cross-sectional side views of molding systems for creating a reinforced elastomer product with an open micro-chamber in accordance with illustrative embodiments. The molding systems, which can be similar to the molding systems described with reference to FIGS. 29A-29E, are illustrated in the closed configuration. Each of the molding systems includes a top mold tool 700 and a bottom mold tool 705. The molding system of FIG. 30A includes a plurality of posts 710 having a first diameter and the molding system of FIG. 30B includes a plurality of posts 715 having a second diameter, where the first diameter is larger than the second diameter. In alternative embodiments, additional or fewer posts may be used.

In an illustrative embodiment, posts 710 and posts 715 contact an outer surface of a reinforcement shell 720 that is to be molded into an elastomer embodiment. Posts 710 and posts 715 are used to provide support and help secure reinforcement shell 720 during the injection molding process. An insert 725 is placed into an interior of reinforcement shell 720 such that the elastomer does not entirely fill the interior of reinforcement shell 720, resulting in an open micro-chamber. Insert 725 includes a plurality of fins 730 corresponding to posts 710 and posts 715. In alternative embodiments, fewer or additional fins may be used. Fins 730 help to maintain a shape of reinforcement shell 720 during the injection molding process. Fins 730 may also contact reinforcement shell 720 at locations adjacent to the locations of posts 710 and posts 715 to help secure reinforcement shell 720 during the injection molding. Upon injection of an elastomer into the molding system, the elastomer extends into the interior of reinforcement shell to surround insert 725 such that reinforcement shell 720 is encapsulated by the elastomer. After the reinforced elastomer is molded, insert 725 can be left inside reinforcement shell 720 or removed, depending on the embodiment. In one embodiment, insert 725 may extend for only a portion of the length of reinforcement shell 720.

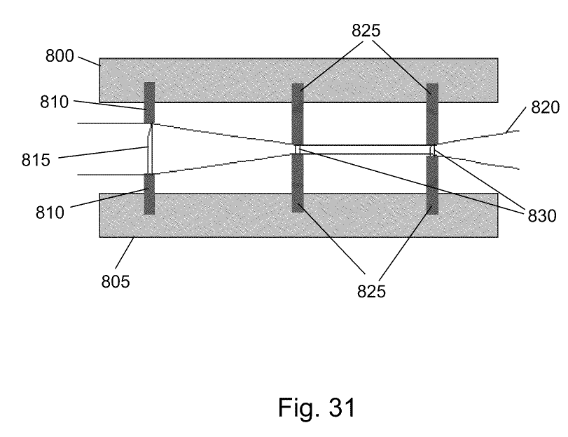

FIG. 31 is a partial cross-sectional side view of a molding system for compressing portions of a reinforcement shell in accordance with an illustrative embodiment. The molding system includes a top mold tool 800 and a bottom mold tool 805, which can be similar to the embodiments described with reference to FIGS. 29 and 30. The molding system includes first posts 810 having a first length and a first holding pin 815 that extends between first posts 810. In an illustrative embodiment, the first length of first posts 810 is such that first posts 810 contact a portion of a surface of a reinforcement shell 820 that is in an uncompressed state. The molding system also includes second posts 825 having a second length and second holding pins 830 that extend between corresponding pairs of second posts 825. The second length of second posts 825 is such that at least a portion of reinforcement shell 820 is compressed when top mold tool 800 and bottom mold tool 805 are in the closed configuration as illustrated in FIG. 31. As described with reference to FIG. 29, first holding pin 815 and second holding pins 830 are used to secure reinforcement shell 820 in place during the injection molding process.

Compressing one or more portions of reinforcement shell 820 allows different portions of the reinforced elastomer product to have different amounts of flexibility. For example, the portion of the reinforced elastomer product that includes an uncompressed portion of reinforcement shell 820 is less flexible (and has less wiggle) than the portions of the reinforced elastomer product that include compressed portions of reinforcement shell 820. FIG. 31 illustrates a closed micro-chamber embodiment. In alternative embodiments, an insert can be used to form a reinforced elastomer with a compressed shell and an open micro-chamber.

As discussed above, the inventor has perceived that traditional soft elastomer-based products have been prone to failure by ripping and tearing during regular use by end users. As such, the inventor has perceived of the reinforced elastomer embodiments described herein to create longer lasting more durable products. Often it can be the case that the ripping and tearing of soft elastomer products renders the products useless or defective. Additionally, failure of soft elastomer components can often render whole product assemblies undesirable and therefore useless. This effect can be undesirable for consumers and for the environment as these products can take many hundreds of years to break down in nature and can end up either in landfills discarded as waste, or often at no fault of end users, as waste scattered about the environment.

Examples of soft elastomer component failure can be found in implement handles that rip and tear off after several uses such as handle bar coverings and grips, railing hand hold coverings and grips, ladder grips, crutch underarm padding and hand grips, handicapped walkers padding and grips, hand hold grips of all kinds, soft elastomer pen/pencil grips, foamed elastomer swimming noodles, foamed elastomer life guard buoys, life preservers, helmet padding of all types, arm rests, chewy elastomer animal toys, soft dog retriever dummies, etc. In these examples, once ripping and tearing takes place, it renders use of the product or its component assembly of associated products unsatisfactory. In many instances, these products are discarded or rarely used again.

Reinforcement of soft elastomer products presents a wide range of products having superior robustness and usability. An illustrative reinforced elastomer product can be a fishing lure as described herein. Additional reinforced elastomer products include reinforced soft polymer handles and handholds for the lawn and garden industry, vehicular reinforced handles, steering wheel covers, bicycle/motorcycle handlebar grips, vehicular door runners, etc. Military applications include reinforced soft handles and handholds for military transport vehicles in sea, land, and air operations, handles for heavy and medium weight military hardware of all kinds used to carry and tote military hardware of all types in the field, in combat, in training exercises, or civilian use, rope ladder rungs for use in sea, land, and air operations, etc. For the sporting goods industry, reinforced soft elastomer products can include handles or handle wraps for golf clubs, tennis rackets, fishing rods, hockey sticks, etc.

Additional reinforced elastomer applications include running belts for machinery, reinforced polymer washers and gaskets/seals of all kinds for creating regular or high pressure seals for any use, stair and other railing hand hold coverings and grips, interior and/or exterior helmet protection for bicycle helmets, sporting equipment helmets, motorcycle helmets, helmet protection for football and baseball and all kinds, etc. The reinforced elastomer can also be used for grips on crutches, underarm support for crutches, grips on wheel chairs, grips on hospital beds, and grips for other medical products used in the medical industry. In one embodiment, the reinforced elastomer can be used to replace tendons and/or ligaments in humans and animals. For example, an embodiment can be of architectures that can allow intermodal fluid injection into a cavity or micro-chamber of the reinforced elastomer during or after the molding phase to mimic the softness and collapsible characteristics of body tissue. Another embodiment can be the use in artificial joint replacement within architectures designed for implementation and incorporation into joint architectures as strengthening ligaments, tendons, or other to support overall functioning of the device. The reinforced elastomer can also be used for regenerative tissue replacement, etc. As such, the reinforced elastomer can be used internally (i.e., within the body of a subject). The embodiments described herein can also be used in prosthetic orthopedic devices, artificial limbs, etc. that may be internal or external to the body of the subject.

Embodiments can also be used in archictectures assembled as panel and component protection for civilian and military use for blast, vibration, acoustic and sound proofing applications. Embodiments can also be used for military and civilian applications as blast, vibration and acoustic protection in helmets, vest and body armor protection, etc. Embodiments can also be used for protection against blasts, vibration and acoustic for military and civilian vehicles used in sea, land and air operations. The reinforced elastomer can further be used for pencil/pen grips, a soft swimming noodle, life guard buoys, life preservers, chewy elastomer toys for animals, dog retriever dummies, etc.

The reinforced elastomer can also be used for partial or complete component encapsulation for components such as homing devices, global positioning system devices, high or low frequency transmitting devices, acoustic emission devices, rattles, light bulbs, light strobes, weights, floatation, additional reinforcement, fluids of various nature, etc. In such an embodiment, components to be encapsulated are placed between holding pins in a mold for securing a reinforcement shell such that the reinforcement shell and the components are held secure and with precision during the molding process. Embodiments utilizing encapsulation embodiments can be incorporated into clothing and other textile articles, into personal carrying bags and other equipment carrying devices in all domains, into equipment and article used in and for military and civilian uses, military and civilian articles and equipment in general, military and civilian search and rescue equipment and articles used for land, sea and air use, etc.

Embodiments described herein of a reinforced soft elastomer have the ability to hold up under very strenuous conditions, offering dynamic and durable soft plastic strength, reinforcement and ergonomic qualities that substantially reduce cut off of blood circulation in fingers or hands gripping these reinforced soft elastomer products or components thereby providing embodiments that can allow longer hand hold and grip ability desired for use conditions. This provides transformational improvements and a substantially longer product life for a variety of conventional, industry, civilian and military products and components and development of a large array of new products. The embodiments described herein render dynamic strength to soft elastomer handholds and products of all kinds, which may be injection molded or extruded. Specifically, when a user grips a soft elastomer handgrip strongly, vascular circulation is not cut off as rapidly as with a hard, rigid handhold.

The reinforced elastomers described herein present an array of soft, durable, dynamic strength handholds of all sorts, railing hand holds of all kinds, ladder rung sleeves of all kinds, weapons and weapon system handholds; ammunition box handholds, civilian and military vehicle, aircraft, boat, and ship handholds and railing components. As such, military personnel can hold heavy objects and run in battlefield situations with very soft yet secure handholds and handles on their various combat ready equipment and supplies with substantially longer hold times as circulation to fingers and hands is preserved, and the handholds do not fail. For example, military personnel can run with heavy military equipment under battle conditions (such as M-60s, heavy mortar and anti-tank missile equipment, and related heavy ammo boxes) without losing circulation or dropping their loads. Similarly, tactical units can enter and exit battlefield situations rapidly while gripping soft yet dynamically tough soft reinforced elastomer rope ladders, rungs, or handholds of all kinds in helicopters, in planes, on ships, in amphibious vehicles, on tanks, and in troop transport vehicles, etc.

In other embodiments, reinforced architectures can be side-by-side layered reinforcement or multiple sheets of layered embodiments that can provide physical, blast, vibration and acoustic protection for a variety of conventional, industry, civilian and military applications. Examples of such military grade embodiments can be insertable and/or assembled helmet and personnel protection vests and body armor of all kinds; blast, vibration and acoustic protection panels for military and civilian vehicles of all locomotion—for sea, land and air use. For sporting goods and equipment, uses could be for sporting equipment articles worn, shock and acoustic absorption protection panels of all kinds needed and appropriate for and at sporting venues, for reinforced, shock absorbing in-helmet insert assemblies and other worn equipment articles. For general and heavy industrial applications such the construction industry, embodiments can provide vibration and acoustic protection panels for vehicular, helmet and body protection that can be incorporated into protecting work chambers, work areas, equipment, vehicles and personnel. Embodiments applications for civilian, industrial and military use are not limited to those listed above.

According to illustrative embodiments, the modular reinforced elastomer product system represents transformational, industry-wide improvements for contemporary soft elastomer architectures in their manufacture and use by end-users through innovative and modular structural reinforcement technology and accompanying component sub-technologies.

One object of the illustrative embodiments is a scalable, modular, innovative reinforced soft elastomer product and component platform made by way of specific manufactured structural reinforcement technology designed to significantly enhance soft elastomer strength and associated expandability characteristics, that can hold essential soft elastomer properties of being soft and highly flexible, and having high tensile strength.

In one embodiment, tubular, expandable Fiber-Braided Reinforcement Shell (FBRS) technology can be used to implement a modular elastomer product reinforcement system platform. The illustrative embodiments can include the following scalable and interchangeable modular technology components: Fiber-Braid Reinforcement Shell (FBRS) Technologies, Micro-Fiber Flocking Reinforcement (MFFR) Compounding Technologies, Micro-Chamber (MC) Technologies, Designed for Assembly (DFA) and Designed for Manufacture (DFM) Lock-On Technologies, Designed for Assembly (DFA) and Designed for Manufacture (DFM) Sub-Chamber Lock (SCL) Technologies, etc.

Core soft elastomer strengthening characteristics can be achieved by placement of made-to-spec tensile strength, single or multiple, flexible, expandable, fiber-braided reinforcement shells (FBRS) into soft elastomer molding during product or component manufacture. The fiber braid reinforcement shells can provide protective, yet expandable structural support to soft elastomer products or component encapsulation and a modular elastomer product reinforcement system platform. Supplemental to soft elastomer strengthening advantages, fiber-braided reinforcement shells can be fabricated highly reflective or of chosen color characteristics as an interchangeable modular design system component for placement within translucent or non-translucent elastomer depending on design characteristics desired for products or components.

Micro-Fiber Flocking Reinforcement (MFFR) technology, as an additional interchangeable component of illustrative embodiments, provides additional elastomer compounding reinforcement properties for products and components. Flavored or unflavored elastomer compounding for soft elastomer manufacture can be another modular, mix and match component of this modular elastomer product reinforcement system.

Open or closed micro-chambers within narrowly expandable fiber-braided reinforcement shell and notched sub-chamber lock technologies allow product or component system scalability and modular interchangeability of snuggly held or loosely fitting insert media. Closed micro-chamber FBRS-reinforced technologies also allow soft elastomer product manufacturers mix and match options to mold in modular insert media directly into products within the hold and protection of FBRS technology during injection molding, extrusion, or other production processes known in the art. FBRS technologies can provide capability for modular reinforced products or components to be locked on by the manufacturer or by the end-user at one or more selected positions within the reinforced product. This can be accomplished with manufacturing sub system attachment assemblies as they are passed through and within the tubular reinforcement shells. The modular reinforced elastomer product platform of illustrative embodiments can utilize a single or multiple reinforcement shell technology platform.

In one embodiment, the reinforcement shells described herein can be coated with an adhesive or other substance to promote bonding of the reinforcement shell with the elastomer. The reinforcement shell can be made from a carbon fiber, carbon nano-fiber, and/or any other fiber known to those of skill in the art. The elastomers described herein can be a rubber-like substances of any kind such as natural or synthetic rubber and comparable polymer elastomeric substances. The elastomers can be synthetic materials that behave like rubber but made from synthetic polymers superior to rubber in mechanical or chemical properties. Elastomeric polymers that can be formulated as elastomers can be polyurethane, butyl rubber, silicones and specially treated ethylene-propylene copolymers.

The elastomers described herein can also be unsaturated rubbers elastomers that can be cured by sulfur vulcanization and can include natural rubber (NR), synthetic polyisoprene (IR), Butyl rubber (copolymer of isobutylene and isoprene, IIR)—halogenated butyl rubbers (chloro butyl rubber: CIIR; bromo butyl rubber: BIIR), polybutadiene (BR), styrene-butadiene rubber (copolymer of polystyrene and polybutadiene, SBR), nitrile rubber (copolymer of polybutadiene and acrylonitrile, NBR), also called buna N rubbers—hydrogenated nitrile rubbers (HNBR), therban and zetpol, chloroprene Rubber (CR), polychloroprene, Neoprene, Baypren etc.

The elastomers described herein can also include saturated rubbers elastomers that cannot be cured by sulfur vulcanization, and can include EPM (ethylene propylene rubber, a copolymer of ethylene and propylene) and EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone Rubber (FVMQ), fluoroelastomers (FKM, and FEPM) Viton, Tecnoflon, Fluorel, Aflas and Dai-El, perfluoroelastomers (FFKM) Tecnoflon PFR, Kalrez, Chemraz, Perlast, polyether Block Amides (PEBA), chlorosulfonated Polyethylene (CSM), (Hypalon), ethylene-vinyl acetate (EVA)

The elastomers described herein can further include other types of elastomers such as thermoplastic elastomers (TPE), for example Elastron, etc., thermoplastic vulcanizates (TPV), for example Santoprene TPV, thermoplastic polyurethane (TPU), thermoplastic olefins (TPO), the proteins resilin and elastin, polysulfide rubber.

The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A molding system comprising:
a top mold;
a first post mounted to the top mold, wherein the first post is configured to contact an outer surface of a reinforcement shell when the molding system is in a closed configuration;
a bottom mold;
a second post mounted to the bottom mold, wherein the second post is configured to contact the outer surface of the reinforcement shell when the molding system is in the closed configuration; and
a holding pin mounted to one of the first post or the second post, wherein the holding pin is configured to secure the reinforcement shell in place when the molding system is in the closed configuration.

2. The molding system of claim 1, wherein the holding pin is in contact with the first post and with the second post when the molding system is in the closed configuration.

3. The molding system of claim 1, wherein the holding pin is mounted to the second post, wherein the holding pin extends into an interior of the reinforcement shell when the molding system is in the closed configuration, and wherein the holding pin does not contact the first post when the molding system is in the closed configuration.

4. The molding system of claim 1, wherein the holding pin has a tapered end.

5. The molding system of claim 1, wherein the holding pin is mounted to the second post, and further comprising a sheath mounted to the first post, wherein the sheath comprises a receptacle configured to receive at least a portion of the holding pin when the molding system is in the closed configuration.

6. The molding system of claim 5, wherein at least a portion of the sheath extends into an interior of the reinforcement shell.

7. The molding system of claim 6, wherein the sheath comprises a plurality of pins.

8. The molding system of claim 1, further comprising an opening configured to receive an elastomer for molding a reinforced elastomer product that includes the reinforcement shell.

9. The molding system of claim 1, wherein the first post and the second post comprise a first set of posts having a first length such that a first portion of the reinforcement shell that is in contact with the first set of posts is uncompressed, and further comprising a third post mounted to the top mold and a fourth post mounted to the bottom mold, wherein the third post and the fourth post comprise a second set of posts having a second length that is longer than the first length such that a second portion of the reinforcement shell that is in contact with the second set of posts is compressed.

10. The molding system of claim 1, wherein the holding pin comprises a plurality of holding pins mounted to the second post.

11. A method comprising:
placing a reinforcement shell into a molding system that includes a top mold, a first post mounted to the top mold, a bottom mold, and a second post mounted to the bottom mold, wherein the reinforcement shell is placed such that at least one holding pin extends into an interior of the reinforcement shell, wherein the at least one holding pin is mounted to one of the first post or the second post;
placing the molding system into a closed configuration such that the first post and the second post are in contact with an outer surface of the reinforcement shell; and
injecting an elastomer into the molding system to form a reinforced elastomer product that includes the reinforcement shell.

12. The method of claim 11, further comprising:
cooling the molding system; and
removing the reinforced elastomer product from the molding system.

13. The method of claim 11, wherein the holding pin is in contact with the first post and with the second post when the molding system is in the closed configuration.

14. The method of claim 11, wherein the holding pin is mounted to the second post, and wherein a sheath mounted to the first post is configured to receive at least a portion of the holding pin when the molding system is in the closed configuration.

15. The method of claim 11, further comprising compressing a portion of the reinforcement shell with the first post and the second post when the molding system is in the closed configuration.

16. A method comprising:
placing a reinforcement shell into a molding system that includes a top mold, a first post mounted to the top mold, a bottom mold, and a second post mounted to the bottom mold;
placing an insert into an interior of the reinforcement shell, wherein the insert includes a first fin configured to contact the reinforcement shell at a first location adjacent to the first post when the molding system is in a closed configuration and a second fin configured to contact the reinforcement shell at a second location adjacent to the second post when the molding system is in the closed configuration;
placing the molding system into the closed configuration; and
injecting an elastomer into the molding system to form a reinforced elastomer product that includes the reinforcement shell.

17. The method of claim 16, further comprising removing the insert from the reinforced elastomer product to form a cavity within at least a portion of the reinforced elastomer product.

18. The method of claim 16, wherein the reinforcement shell is encapsulated within the elastomer.

19. The method of claim 16, wherein the insert has a hollow interior and is configured to remain in the reinforced elastomer product.

20. The method of claim 16, wherein the reinforced elastomer product comprises at least one of a hand-hold, a rung for a ladder, or a gasket seal.
